(19) United States
(12) Patent Application Publication
(10) Pub. No.: US 2007/0117602 A1
(43) Pub. Date: May 24, 2007

(54) Game mobile element, such as a game piece, and related game system

(75) Inventors: Fabrice Madigou, Andresy (FR); Albert Palombo, Versailles (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: SYLVIUS, PARIS (FR)

(21) Appl. No.: 10/583,651

(22) PCT Filed: Dec. 18, 2003
(86) PCT No.: PCT/FR03/03792

§ 371 Date: Jan. 16, 2007

(30) Foreign Application Priority Data
Dec. 18, 2002 (FR) 0216075

(51) Int. Cl. G06F 19/00

(52) U.S. Cl. 463/14

(57) ABSTRACT

The invention concerns an element such as a game piece (10) or the like designed to be placed on a game board, the game being electronically controlled. The invention is characterized in that it comprises means (100, 102) for wirelessly receiving game control data, control means (100) responsive to the received data, and means (116) for moving the game piece driven by the control means. The invention also concerns an electronic game system comprising such game pieces. The invention is in particular applicable to electronic parlour games on a board with flat display.

This invention generally relates to games, such as parlour games, on an interactive electronic platform.

Many parlour games such as Monopoly®, Trivial Pursuit®, checkers, etc., use pawns that are passive parts in the game and that must be moved and/or modified manually as the game progresses.

Therefore, new technology has not provided any new attraction for this type of game.

At the same time, a great deal of progress has been made in the field of game consoles, in terms of processing performance and display of data, but the user interface usually is still a simple game pad with buttons, directional levers, etc.

However, a certain amount of research has been carried out, at least on paper, on interactivity in electronic games. Thus for example, document GB 2 271 724 A describes a game system in which a game pawn can be excited by energized pads at predefined locations, on the game board, to produce an action. Document FR-2 738 159 A describes a chess game in which electromagnetic coupling between exciters located in the board and coils located in the parts provide a means of displacing the parts. Document U.S. Pat. No. 6,186,158 B1 also describes a chess game in which magnetic means are used to detect the position of parts. Finally, U.S. Pat. No. 6,206,371 B1 describes a device for throwing a dice (or a coin) in which the face on which the dice or the coin falls is detected.

There is also US document U.S. Pat. No. 5,853,327 A that describes a game system with some parts capable of action by a wire or wireless control. However, the “active” parts are accessories that are apparently fixed rather than pawns or game characters, in other words they are limited to a game board without a dynamic display such as an LCD or plasma screen.

The purpose of this invention is to add an additional dimension to games such as parlour games, performed on a flat platform with dynamic display and more particularly to provide new advantages to these games and to help in the creation of new games by facilitating interactivity between the game and the pawn.

To achieve this, according to a first aspect there is an element such as a pawn or a similar piece that can be moved on a game board comprising a dynamic display system, the game being electronically controlled, characterized in that it comprises a means of receiving game control information by wireless transmission, and a control means sensitive to the received information.

Advantageously, the element also comprises a means of animating a pawn controlled by the control means.

According to a second aspect, the invention proposes an electronic game system, characterized in that it comprises:

an electronic game platform comprising a central unit, a memory, a dynamic display device capable of being placed in an essentially horizontal position, at least one input device for the user, and a means of transmitting information by wireless transmission, and

a plurality of pawns that can be moved on the display device, each pawn including a means of receiving information by wireless transmission capable of communicating with the said transmission means, a control means sensitive to the received information, and a means of animating the pawn controlled by the control means.

Preferably, the means of animating a pawn comprises at least one device chosen from the group including light sources, mechanical actuators, sound sources and vibration sources.

Optionally, the element may also include a detection means preferably composed of a device chosen from the group comprising optical sensors, mechanical sensors, electromagnetic sensors, sound sensors and vibration sensors.

It is also advantageous if each pawn has its own address for reception of the said information.

In one preferred embodiment, each pawn is powered by a rechargeable battery, and the platform and the pawns comprise positions for recharging the batteries of the pawns.

Other aspects, purposes and advantages of this invention will become clearer after reading the following detailed description of a preferred embodiment of the invention, given as a non-limitative example with reference to the appended drawings, wherein:

FIGS. 1 to 3 are functional block diagrams showing three examples of pawns according to the invention,

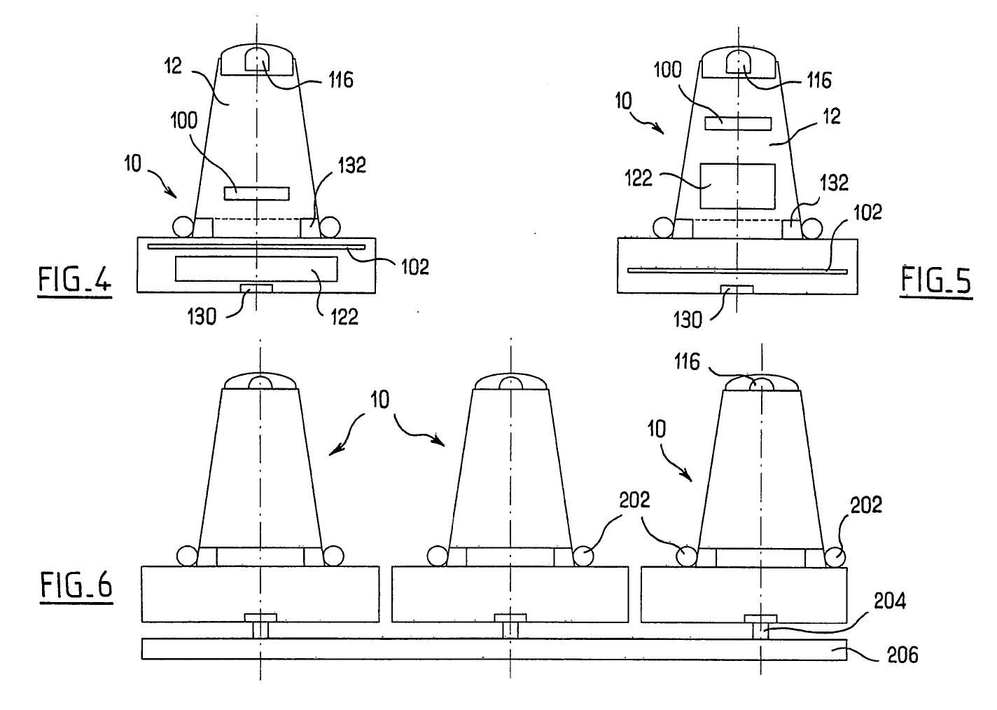

FIGS. 4 and 5 are diagrammatic vertical sections through two examples of pawns according to the invention,

FIGS. 6 and 7 are elevation views of two examples of pawns according to the invention placed on a charger, and

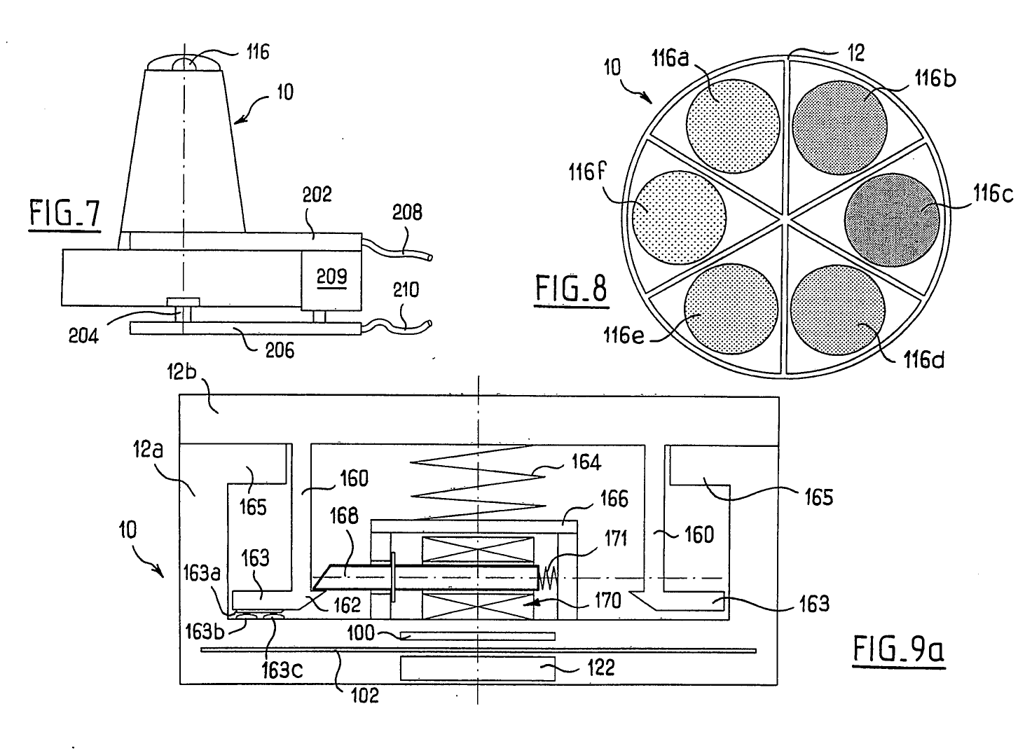

FIG. 8 is a diagrammatic top view of a pawn according to another embodiment, and

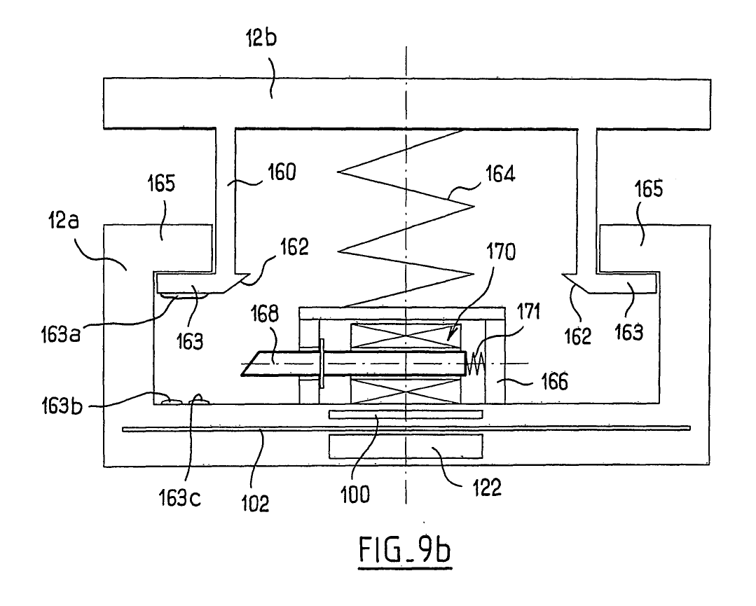

FIGS. 9a and 9b are diagrammatic vertical sections through yet another embodiment of a pawn.

Note initially that the invention is particularly applicable to an electronic game platform like that described in document WO 02 20110 A in the name of the Applicant. This type of platform comprises a wireless communication means (antenna, transmission and possibly reception circuits, interface with game software) for communication with pawns or other elements as will be described below, for implementation of this invention.

FIG. 1 is a functional block diagram showing a first example embodiment of a pawn for an electronic game according to the invention, designed particularly to be moved manually on the horizontal display area of the platform described in the above mentioned document.

The complete pawn is marked with reference 10. It comprises electronic circuitry 100 associated with a transmission/reception antenna 102, a pawn animation device 116, and a detection device 117 comprising one or several sensors. The antenna 102 is tuned to the frequency used, and is connected to a reception amplifier 104 and a transmission amplifier 106.

The output from the reception amplifier is connected to a received signal decoding circuit 108 adapted to the modulation type used. These signals preferably include a coding defining an address of the pawn. This circuit 108 is connected firstly to a circuit 110 putting the electronic circuitry of the pawn on standby, and secondly to a processing unit 112 with a memory.

This unit 112 is connected to a control interface 114 used to selectively activate one or several sound, light, mechanical displacement, vibration, etc. type of animation devices 116, for example one or several light emitting diodes, a piezoelectric vibrator, a control electromagnet for a mobile part of the pawn, etc., as a function of instructions contained in the received radio frequency signals, as will be seen in more detail later.

The unit 112 may also receive signals from one or several sensors 117, for example from optical sensors, electromagnetic sensors, mechanical sensors, sound sensors and/or vibration sensors.

In this embodiment, the processing unit 112 is also connected to an encoding circuit 118 that generates a signal to be transmitted that is amplified by the transmission amplifier, and then applied to the antenna.

The system is powered by a battery (not shown), possibly a rechargeable battery, as will be described later.

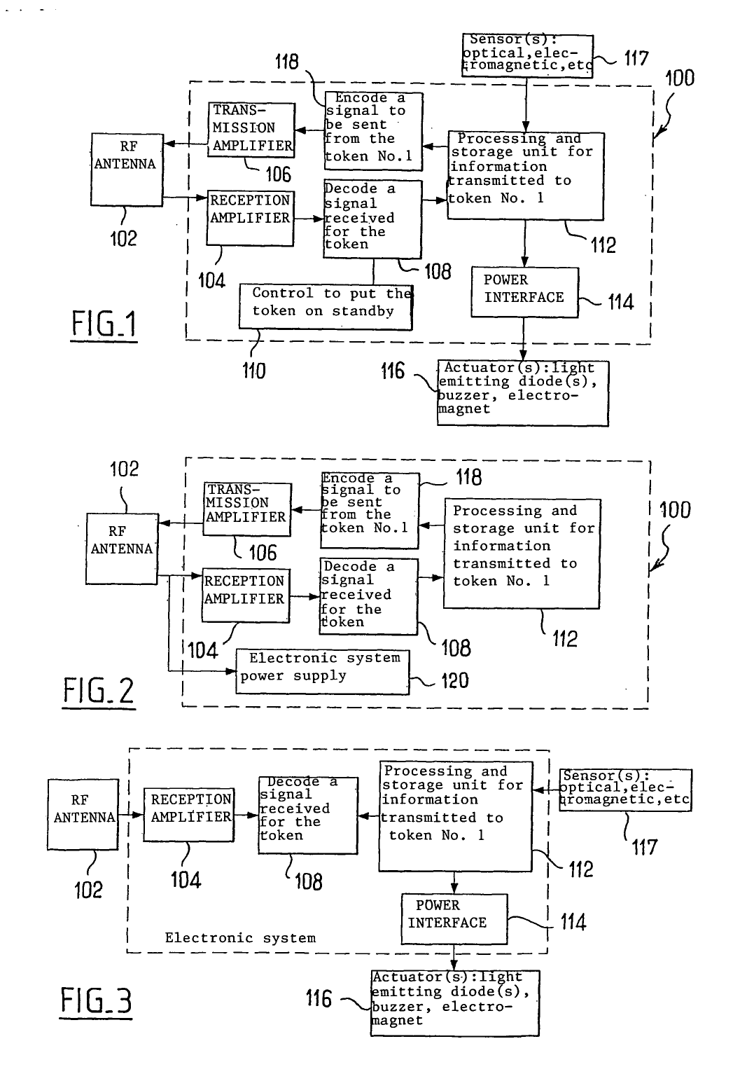

FIG. 2 illustrates the functional architecture of a pawn according to one variant embodiment. In this variant, a specific power supply device 120 is provided comprising a rechargeable battery and a circuit for retrieving energy from the electromagnetic or magnetic flux received by the antenna 102. This type of power supply technique is known particularly in the field of transponders or standalone electronic labels, and will not be described further. For example, magnetic coupling may be achieved using a loop antenna surrounding the display part of the electronic game platform.

FIG. 3 describes another functional variant in which the pawn communicates unidirectionally with the outside, since it is only capable of receiving electromagnetic or magnetic control signals.

This type of pawn can cooperate with transmission-reception circuitry or transmission circuitry only, forming part of the electronic game platform.

FIG. 4 shows a possible example of the physical structure of the pawn 10. It comprises a body 12, preferably made of an injected plastic material, containing the electronic circuitry 100, a battery 122 that is a rechargeable battery in this case, the transmission—reception antenna 102, in this case a flat coil arranged horizontally near the bottom of the pawn, and an animation device in this case in the form of a light emitting diode LED 116 placed near the top of the pawn so that it is visible.

The pawn also comprises a first contact 130 located on its lower face, and a second peripheral and annular contact 132 located just above the region near the bottom of the pawn. When the pawn 10 is placed on a recharging base as will be seen later, the battery 122 is recharged through these contacts by an appropriate charging circuit.

In this respect, note that according to known techniques for wakening and putting on standby, it is possible to automatically put some of the pawn's electronic circuits on standby in case of inactivity, using techniques also known in the field of battery powered transponders, and to waken them by appropriate awakening signals.

FIG. 5 illustrates a variant of the layout of the pawn in which the electronic circuit 100 is located above the battery 122.

FIG. 6 diagrammatically illustrates a charger device designed to hold a series of pawns 10 so that they can be recharged. For example, this device may be a region of the housing of an electronic game platform like that described particularly in the above mentioned document WO 02 20 110 A, or it may form a standalone and independent device.

This device, for which the support or retaining parts of the pawns themselves have not been shown for reasons of clarity, comprises a series of conducting strips 202 connected together and a series of conducting pads 204 connected together by a conductor 206, corresponding with the corresponding strips, the strips and the pads being connected to a regulated voltage source provided in the game platform, to recharge the batteries 122 of the different pawns 10 when they are in this position.

FIG. 7 illustrates another view of the recharging device. The pawns 10 are placed in the charger laterally along the direction of the arrow F, and a stop part 209 holds the pawns in position.

The conductors carrying the recharge voltage to the strips 02 and the pads 204 are shown as 208, 210.

Other recharging techniques could be used, particularly contact free recharging by induced current, in a manner known in itself.

FIG. 8 illustrates a top view of a disk-shaped pawn with a given thickness comprising six different coloured illuminated areas 116a-116f, each controlled independently of the others, for example using LEDs associated with colour filters.

FIGS. 9a and 9b illustrate a variable shaped pawn, the body of which is composed of two generally hollow cylindrical parts 12, 12b that can slide with respect to each other. These parts are separated from each other by means of an internal pressure spring 164 operating between a bottom face of the top element 12b and the top of a housing 166 containing an electromagnet 170 in which there is a return spring 171 as will be seen in detail later.

Parts 12a and 12b are retained in contact with each other by arms 160 that extend downwards from the top of part 12b and are fitted with bottom plates 163 on the outside that stop near the top in contact with a reentrant rim 165 of part 12a. At least one of these arms 160 is provided with a tooth 162 on the inside that cooperates with a mobile latch 168 activated by the electromagnet.

FIG. 9a also shows the antenna 102 near the bottom of the lower part 12a of the pawn and the battery 122 above the antenna.

In the position in FIG. 9a, the latch 168 retains the part 13a in the down position cooperating with the tooth 162, in opposition to the force exerted by the spring 164. In this position, a contact 163a located under the base 163 establishes an electric contact between the other two contacts 163b, 163c facing it on the bottom of part 12a.

When the electromagnet 170 is activated by the control electronics 100, the latch 168 is moved towards the right looking at FIG. 9, and part 12b is released. The spring 164 can then apply a force as far as the position illustrated in FIG. 9b, in which the bases 163 of the part 12b have limited the movement by stopping in contact with the rim 165 of part 12a. The pawn is thus globally taller than in the situation in FIG. 9a. The contact 163a no longer short circuits contacts 163b and 163c.

All that is necessary to bring the pawn back into the position shown in FIG. 9a is to apply a manual pressure until the tooth 162 engages behind the latch 168, the latch returning to its original position after the electromagnet has been activated by action of the spring 171 on the latch 168.

Note here that the contacts 163a-163c are used to inform the circuit 100 about the relative position of parts 12a and 12b, the contacts 163b and 163c consequently being connected to an appropriate input of the circuit 100.

Parts 12a and 12b are preferably assembled together by a bayonet or similar mechanism.

Preferably, this electronic circuit is made on a single semi conducting chip.

Specifically, each pawn is capable of receiving and memorizing a certain amount of information as a function of progress with the game, such as a parlour game in which the pawn is used, using its components described above.

As described above, animation of the pawn may include a modification to its physical aspect (colour, shape, etc.), but also or alternately to the emission of sounds, vibrations, etc.

As already mentioned, the game platform includes radio frequency transmission means and possibly reception means, these transmission means enabling it to transmit control information to pawns and to control their animation, in response to instructions given by a program executing the game in question.

Note that most games are played with several pawns. In this case, the system will use addressing means that are conventional particularly in the field of transponders or contact free electronic labels, to differentiate instructions sent to one pawn from instructions sent to another pawn.

There are many examples of the use of this invention.

Thus, FIG. 8 illustrates a pawn for the Trivial Pursuit® game, in which a sector of one colour lights up when the player gives the right answer on a box with the corresponding colour. The pawn may include six light emitting diodes (LEDs) that light up for each right answer.

In a Monopoly® type game, a pawn may correspond either to movements of a player, or to a house or hotel placed on a street. The colour and the number of light sources may denote houses and the number of houses (for example three green LEDs lit up denote three houses) or a hotel (a red LED).

For a checkers game, the height of each pawn illustrated in FIGS. 9a and 9b may be approximately doubled when the pawn reaches the opponent's baseline.

Many variants and modifications can be made to the invention.

Firstly, the wireless transmission technology between the game system and a pawn may be of any type and particularly be based on radio frequency, low frequency magnetic coupling, ultrasound, infrared, etc.

Secondly, the size and shape of the body of the pawn may vary considerably depending on the type of the game.

1. Element such as a pawn (1) or a similar piece that can be moved on a game board comprising a dynamic display system, the game being electronically controlled, characterised in that it comprises a means (100, 102) of receiving game control information by wireless transmission, and a control means (112, 114) sensitive to the received information.

2. Element according to claim 1, characterised in that it also comprises a means (116) of animating a pawn controlled by the control means (112, 114).

3. Element according to claim 2, characterised in that the animating means (116) comprises at least one device chosen from the group including light sources, mechanical actuators, sound sources and vibration sources.

4. Element according to one of claims 1 to 3, characterised in that it also includes a detection means (117).

5. Element according to claim 4, characterised in that the detection means is composed of at least one device chosen from the group comprising optical sensors, mechanical sensors, electromagnetic sensors, sound sensors and vibration sensors.

6. Element according to one of claims 1 to 5, characterised in that it has its own address for reception of the said information.

7. Element according to either claim 1 or 6, characterised in that it is powered by a rechargeable battery, and in that it comprises positions for reception of a battery recharging current.

8. Electronic game system, characterised in that it comprises:
an electronic game platform comprising a central unit, a memory, a dynamic display device capable of being placed in an essentially horizontal position, at least one input device for the user, and a means of transmitting information by wireless transmission, and
a plurality of pawns (10) that can be moved on the display device, each pawn including a means (100, 102) of receiving information by wireless transmission capable of communicating with the said transmission means, a control means (112, 114) sensitive to the received information, and a means (116) of animating the pawn controlled by the control means.

9. System according to claim 8, characterised in that the means of animating a pawn comprises at least one device chosen from the group including light sources, mechanical actuators, sound sources and vibration sources.

10. System according to either claim 7 or 8, characterised in that each pawn has its own address for reception of the said information.

11. System according to one of claims 8 to 10, characterised in that each pawn is powered by a rechargeable battery, and the platform and the pawns comprise positions for recharging the pawn batteries.
